(19) United States
(12) Patent Application Publication
(10) Pub. No.: US 2002/0194315 A1
(43) Pub. Date: Dec. 19, 2002

(54) Device and method for linking automation components

(76) Inventors: Dieter Gollwitzer, Postbauer-Heng (DE); Heinrich Kulzer, Nurnberg (DE); Stefan List, Furth (DE); Andreas Macher, Neumarkt (DE); Josef Portner-von-der Marwitz, Nurnberg (DE)

Correspondence Address: BAKER & BOTTS, 30 ROCKEFELLER PLAZA, NEW YORK, NY, 10112

(21) Appl. No.: 10/149,529

(22) PCT Filed: Nov. 29, 2000
(86) PCT No.: PCT/DE00/04249

(30) Foreign Application Priority Data
Dec. 8, 1999 (DE) 199 59 245.4

(51) Int. Cl. G06F 15/177

(52) U.S. Cl. 709/220

(57) ABSTRACT

The invention relates to a device and method for configuring, projecting, documenting and/or diagnosing modules and/or automation components in an automation system or process control system. The aim of the invention is to link automation components into an engineering system of the automation system or process control system. To this end, a released interface which is, in particular, versioned is provided via which a software component of an automation component couples to the engineering system. The automation component is made known to the engineering system and offers its functionality thereto. The software component can likewise interrogate relevant information of the engineering system via corresponding interfaces.

The invention a device and method for configuring, planning and designing, documenting and/or diagnosing modules and/or automation components in an automation system or process control system.

The invention is based on the object of specifying a device and a method which easily permits automation components to be integrated into an engineering system.

This object is achieved by means of a device for configuring, planning and designing, documenting and/or diagnosing modules and/or automation components in an automation system or process control system, having at least one public interface, which is in particular versioned, via which a software component couples to an engineering system for the running time.

This object is by a method for configuring, planning and designing, documenting and/or diagnosing modules and/or automation components in an automation system or process control system, having at least one public interface, which is in particular versioned, via which a software component couples to an engineering system for the running time.

The invention is described and explained in more detail below with reference to exemplary embodiments illustrated in the figures, in which:

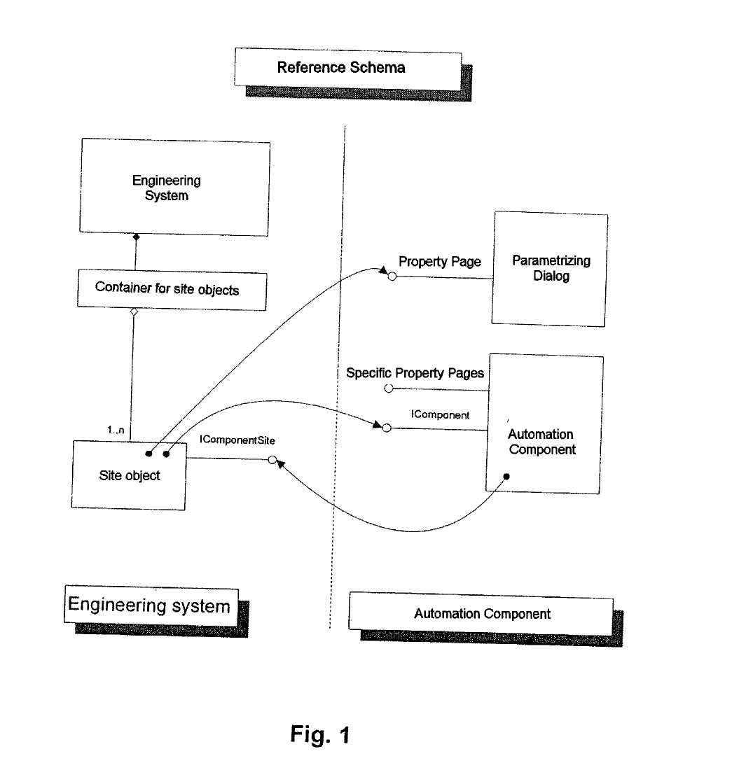

FIG. 1 illustrates a first example of a reference schema for the integration of automation components based on defined interfaces,

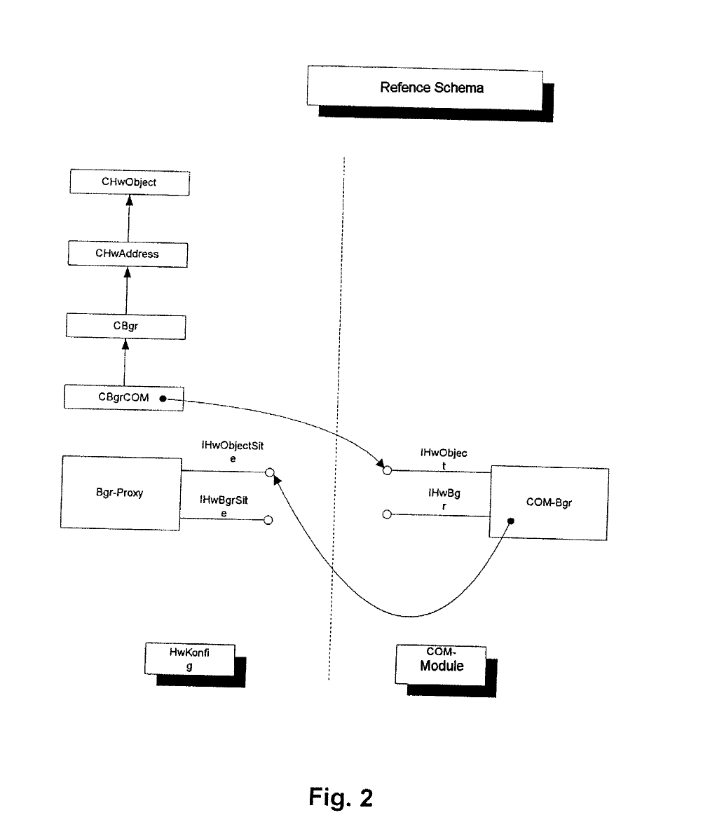

FIG. 2 shows an example further example of a reference schema for the integration of automation components based on defined interfaces, and

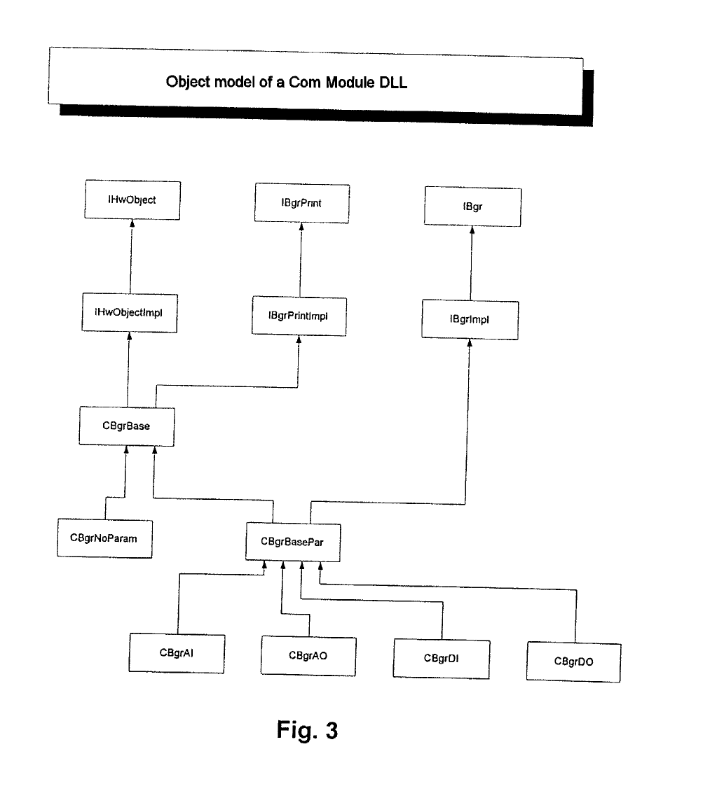

FIG. 3 shows an example of an object model of a COM module DLL.

The invention is based on the use of versioned public interfaces via which the software component couples to the engineering system for the running time. Via these interfaces, the engineering system is informed of the component and provided with its functionality. Likewise, the software component can interrogate relevant information of the engineering system via corresponding interfaces.

At the time of creation of the component, no files (header files or libraries) of the engineering system are required.

Only the specification of the interfaces is required.

Likewise, the presence of the engineering system is not required at the creation time.

The component accesses other components or information of the engineering system by means of defined interfaces. The individual objects which are generated by means of instantiation of the respective components are connected to one another here by means of various relations. These relationships are defined by means of an abstract object model. The engineering system determines, by reference to the respective relation, those objects which have the stated relation with the inquiring entity of the component. Additional information relating to class objects or object models of the engineering system is not necessary here.

The components independently determine whether separate subcomponents are to be used for specific functions or corresponding subcomponents of the engineering system are to be used.

The invention permits

implementation of a software component, representing a device for example, independently of the engineering system. The components are based here on standard technologies, for example the COM/DCOM model of Microsoft or the CORBA model of the Object Management Group (OMG) which permit the components to be used both on the same computer as the engineering system and also distributed in a computer network.

Likewise, the simultaneous use of the components in various engineering systems is possible. The basis of this is an instantiation model.

flexible, component-related implementation of planning, design and diagnostic functions as the respective information can be created and/or interpreted on a component-specific basis.

context-related interpretation of the information by the respective component. In this way, both use-specific behavior of module can be controlled (for example the central or decentralized use), and security-oriented aspects (for example access via authorization) can be implemented uniformly.

The invention lies in the fact that the integration of automation components into an engineering system takes place only via a corresponding interface specification which can be implemented on the basis of COM/DCOM or CORBA.

In summary, the invention thus relates to a device and method for configuring, planning and designing, documenting and/or diagnosing modules and/or automation components in an automation system or process control system. To integrate automation components into an engineering system of the automation system or process control system it is proposed that the engineering system have a for coupling to the engineering system. The software component couples to the engineering system via the interface. The engineering system is informed of the automation component and provided with its functionality. Likewise, the software component can interrogate relevant information of the engineering system via corresponding interfaces.

1. A device for configuring, planning and designing, documenting and/or diagnosing modules and/or automation components in an automation system or process control system, having at least one public interface, which is in particular versioned via which a software component couples to an engineering system for the running time.

2. The device as claimed in claim 1, characterized in that the engineering system is informed of the component, and provided with its functionality, via the interface.

3. The device as claimed in claims 1 or 2, characterized in that the interface is provided for interrogating relevant information of the engineering system by means of the software component.

4. The device as claimed in one of claims 1 to 3, characterized in that the component accesses other components or information of the engineering system by means of defined interfaces.

5. The device as claimed in one of claims 1 to 4, characterized in that the individual objects which are generated by means of instantiation of the respective components are connected to one another via various relations.

6. The device as claimed in one of claims 1 to 5, characterized in that the relations and relationships are defined by means of an abstract object model.

7. The device as claimed in one of claims 1 to 6, characterized in that, by reference to the respective relation, the engineering system determines those objects which have the stated relation with the inquiring entity of the component.

8. The device as claimed in one of claims 1 to 7, characterized in that the components independently determine whether separate subcomponents are to be used for specific functions or corresponding subcomponents of the engineering system are to be used.

9. The device as claimed in one of claims 1 to 8, characterized in that the components are based on standard technologies, for example the COM/DCOM model of Microsoft or the CORBA model of the Object Management Group (OMG) which permit the components to be used both on the same computer as the engineering system and also distributed in a computer network.

10. The device as claimed in one of claims 1 to 9, characterized in that an instantiation model is provided.

11. The device as claimed in one of claims 1 to 10, characterized in that a context-related interpretation of the information by the respective component is provided in such a way that both use-specific behavior of module is controlled, in particular a central or decentralized use, and/or security-oriented aspects, in particular an access via authorization, are implemented uniformly.

12. The device as claimed in one of claims 1 to 11, characterized in that the integration of automation components into the engineering system takes place only via a corresponding interface specification which is implemented in particular on the basis of COM/DCOM or CORBA.

13. A method for configuring, planning and designing, documenting and/or diagnosing modules and/or automation components in an automation system or process control system, having at least one public interface, which is in particular versioned, via which a software component couples to an engineering system for the running time.

14. The method as claimed in claim 13, characterized in that the engineering system is informed of the component, and provided with its functionality, via the interface.

15. The method as claimed in one of claims 13 or 14, characterized in that the interface is provided for interrogating relevant information of the engineering system by means of the software component.

16. The method as claimed in one of claims 13 to 15, characterized in that the component accesses other components or information of the engineering system by means of defined interfaces.

17. The method as claimed in one of claims 13 to 16, characterized in that the individual objects which are generated by means of instantiation of the respective components are connected to one another by means of various relations.

18. The method as claimed in one of claims 13 to 17, characterized in that the relations and relationships are defined by means of an abstract object module.

19. The method as claimed in one of claims 13 to 18, characterized in that, by reference to the respective relation, the engineering system determines those objects which have the stated relation with the inquiring entity of the component.

20. The method as claimed in one of claims 13 to 19, characterized in that the components independently determine whether separate subcomponents are to be used for specific functions, or corresponding subcomponents of the engineering system are to be used.

21. The method as claimed in one of claims 13 to 20, characterized in that the components are based on standard technologies, for example the COM/DCOM model of Microsoft or the CORBA model of the Object Management Group (OMG) which permit the components to be used both on the same computer as the engineering system and also distributed in a computer network.

22. The method as claimed in one of claims 13 to 21, characterized in that an instantiation model is provided.

23. The device as claimed in one of claims 13 to 22, characterized in that a context-related interpretation of the information by the respective component is provided in such a way that both use-specific behavior of module is controlled, in particular a central or decentralized use, and/or security-oriented aspects, in particular an access via authorization, are implemented uniformly.

24. The device as claimed in one of claims 13 to 23, characterized in that the integration of automation components into the engineering system takes place only via a corresponding interface specification which is implemented in particular on the basis of COM/DCOM or CORBA.
